(19) United States
(12) Patent Application Publication
(10) Pub. No.: US 2004/0135821 A1
(43) Pub. Date: Jul. 15, 2004

(54) Activity record maintenance and display tool

(76) Inventor: Joseph M. Mazzeo, Novato, CA (US)

Correspondence Address: Gregory S. Smith, P.O. Box 88148, Atlanta, GA, 30356, US

(21) Appl. No.: 10/340,336

(22) Filed: Jan. 10, 2003

(51) Int. Cl. G09G 5/00

(52) U.S. Cl. 345/848

(57) ABSTRACT

A method for displaying data fields is described, illustrated and claimed. The present invention can be described as a novel system and method for displaying data fields in close proximity to accompanying label and summary information to facilitate ease of understanding and time efficiency. Label and summary information are fixed within a display window with accompanying data. The data can be scrolled or otherwise moved within the window for display while the label and summary information remain fixed to identify the associated data.

### TECHNICAL FIELD

The present invention relates to three-dimensional modeling and, more particularly, to the housing and three-dimensional display of activity information, such as repairs and inspections, in connection with a device.

### BACKGROUND OF THE INVENTION

In many industries, long-term use, operation-critical components, equipment or devices must be closely monitored to ensure proper operation. Several examples of such industries include the power industry, the airline industry and the construction industry. For instance, in the power industry, power generation equipment, dams, nuclear reactors are a few examples of such operation-critical components. In the airline industry, the aircraft themselves are operation-critical components. In the construction industry, buildings, bridges, high-lift cranes and other structures are examples of operation-critical components. In each of these examples, as well as many other examples not provided, periodic maintenance, routine checks, repairs and other activities need to be performed on the operation-critical components. In addition to these examples, many other examples of components that are not particularly operation-critical, and maybe even not long-term use could also be identified by those skilled in the art.

One of the problems that arise, especially with regards to long-term use components, is maintaining a knowledge base of all the activities that have been performed in relationship to the component. For instance, in the airline industry, maintenance and repairs are constantly being performed on the aircraft. Due to employment attrition of the mechanics, as well as the vast number of records that are created, it can be quite difficult for an individual to fully comprehend the maintenance and repair history of a particular aircraft. This can be very problematic in many situations. For instance, it would be greatly beneficial to have the knowledge that a crack has been repaired in a particular portion of the aircraft, for a technician that is working on a report regarding the detection of vibration from that particular area of the aircraft.

As another example, in the power industry the reliability of a power plant is greatly dependent on the reliability of the boiler. Thus, it is very important to keep track of boiler repair data and data resulting from examinations. Engineers and maintenance planners need this data to track damage trends, hot spots and to plan for future repairs, inspections and boiler tune-ups. Without maintaining good documentation, future repairs and inspections may not have the proper focus. This lack of focus can result in excessive repairs or performing repairs in the wrong location. Thus, what is needed in the art is a tool that maintains historical knowledge regarding activities associated with particular components.

Many industries heavily rely on inspections of operation-critical components. This is especially true in industries in which conducting such inspections can alleviate or reduce the risk of failures that require large-scale replacement or that are life threatening. In such industries, failures are closely tracked along with any maintenance and repairs that are performed. As a result of these efforts, large amounts of data in the form of paper reports, spreadsheets etc. are generated. It is extremely beneficial for this data to be periodically compared to previously obtained data to help identify trends. For instance, in the boiler example, this data has to be reviewed almost as soon as it is generated during a boiler outage. Thus, there is a need in the art for a tool that will simplify the integration of activity data, as well as access to and reviewing of the same.

With the advancements in technology, some industries are increasingly relying on video inspections, radiographic inspections, sonar inspections, audio dictated inspections or the like. All of these advancements, while being very beneficial and precise, result in generating even more data to be reviewed by engineers or technicians. For instance, in the inspection of a boiler, one video examination alone could result in over 10 hours of videotape. Furthermore, comparing the results of inspections using these techniques to previous recorded results is difficult. In addition, since most data obtained through these types of inspections are recorded on a serially oriented media, it is also impractical to compare two locations side by side. Thus, there is a need in the art for a tool that maintains historical knowledge regarding activities associated with particular components that is suitable for handling video, audio, and other forms of recorded information and that can facilitate side by side comparisons of various portions of the component or before and after results.

Therefore, there is a need in the art for a tool that maintains historical knowledge regarding activities associated with components, especially long-term use, operation-critical components, that allows for easily inspecting the historical knowledge in a variety of formats including textual, audio and video, that facilitates side by side comparison data, and generally provides a manageable way to capitalize on the historical knowledge.

### SUMMARY OF THE INVENTION

In general, the present invention can be described as a system and method for displaying activity data for an object. In operation, the system displays a graphical representation of the object. Icons are then overlaid on the graphical representation. Preferably, the icons are located on the overlay in a manner that coincides with a particular physical location on the object. Activity records pertaining to the object are stored in a database or other file means. Each of the data records is associated with at least one particular location on the object and at least one icon. Upon selecting an icon, the data records associated with the icon are retrieved and displayed. The data records received may be subjected to restrictions based on query parameters. The data records can include a variety of information including, but not limited to text files, video clips, video shots, audio files or the like. The objects that are maintained can be any of a variety of objects including boilers, aircraft, water tanks, grain storage bins, or the like.

### BRIEF DESCRIPTION OF THE DRAWINGS

Other aspects, advantages and novel features of the invention will become more apparent from the following detailed description of exemplary embodiments of the invention when considered in conjunction with the accompanying drawings wherein:

FIG. 1 is a screen shot of an exemplary embodiment of the present invention used in conjunction with the front wall in the burner area of a boiler.

FIG. 2 is a screen shot illustrating the presentation of data when a pointing device is positioned over an icon.

FIG. 3 is a screen shot illustrating the display of FIG. 2 when the comments 142 menu item is selected.

FIG. 4 is a screen shot illustrating the display of FIG. 2 when a hyperlink 141 menu item is selected.

FIG. 5 is a screen shot of an embodiment using the raster file aspect of the present invention.

FIG. 6 is a screen shot of another embodiment using the raster file aspect of the present invention.

FIG. 7 is a screen shot of the pipe wall 170 illustrated in FIG. 6 upon selection of the view data menu.

FIG. 8 is a screen shot of the pipe wall 170 illustrated in FIG. 6 upon the selection of an icon representing data for one of the tubes.

### DETAILED DESCRIPTION

In general, the present invention can be described as tool to manage and display activity information regarding a device. More particularly, the present invention allows for activity information, such as maintenance records, repair records, inspection information or the like, that pertains to a particular device to be displayed and accessed in conjunction with a video display of the device or a graphical representation of the device. In one embodiment, activity records for a three-dimensional object are maintained and available for review. To review the information for the object, a graphical representation of the object is provided on a video screen. The graphical representation is overlaid with one or more icons. Each icon represents stored information regarding the object. The icons can be positioned in the overlay in accordance with the area of the object to which the stored information pertains. Alternative methods of associating the icons with particular areas of the object are also anticipated. In addition, alternative means other than icons can be used to indicate the presence of information. In response to selecting an icon, the information represented by the icon is retrieved from a database and visually or audibly provided.

Thus, the present invention can be utilized to graphically display three-dimensional models and link the models to a database of repair, maintenance or examination data. The data that can be linked to can include a variety of data types, including but not limited to bitmap files, jpeg files, tiff files, giff images, other raster files, photographs, scanned drawings, sketches, video files, audio files, text files or any other type of file. Icons are plotted at points of interest, over the graphical displays and are linked to specific data such as repair photos, video clips, repair scope, welding information, repair date etc. The present invention has been implemented in Microsoft Visual Basic and utilized Microsoft Excel files for three-dimensional geometry definition and for data recording.

In one aspect of the present invention, highlights of video inspections are captured on computer files. The files are stored on the computer and are easily activated by clicking an icon that is over-laid on the three-dimensional model of the object. This also works with digitized photos of radiographs or any other type of photo. Side by side comparisons becomes very easy, whether distance, time or both separate the locations.

Another aspect of the present invention is to utilize scanned drawings or sketches instead of three-dimensional models. This aspect of the invention is very useful because many old reports for objects are in existence, and these old reports utilize sketches of an object. It would be very time consuming to model these devices. Implementing this aspect of the presenting invention, the location of the icons can be overlaid over the scanned bit map, and the icons can be linked to repair and or inspection data including radiographic images, repair drawings. In a particular embodiment of this aspect, the invention is used to track the history for piping, a process that generates large amounts of data including radiographic images and repair sketches. This embodiment is used to calculate and present wear rates as well as tracking recommendations for future reinspections of known damage areas being monitored. The re-inspection locations can be highlighted with a unique icon related to date of the required re-inspection.

In an embodiment utilized for three-dimensional models, the present invention automatically overlays icons, representative of repair or test locations, over the three-dimensional model at the related location. In the case of a raster file, the user selects the location for the icon to be displayed on the scanned sketch or drawing by using a pointing device such as a mouse. The three-dimensional graphic or raster file is linked to one or more database files. In operation, the user selects a file that contains the three-dimensional modeling data. This file also contains the name of a second database file that contains repair and/or inspection location data and results. The program automatically finds the second file. Both database files run completely invisibly to the use however the user can optionally open these files to look at the data while the files are being accessed.

An embodiment of the present invention utilized for raster files is ideal for use in existing monitoring efforts where repair/inspection locations have been recorded on sketches and drawings. Such a case is Mirant California's Erosion/Corrosion monitoring program of piping that results in thickness information based on radiographic images that can be stored in the database. The raster file is augmented with the information of the overlay locations as well as the link to one or more database files that contain the examination and repair data.

The three-dimensional modeling data input spreadsheet has a number of options to define geometry including direct global coordinates, offsets and polar coordinates. In some embodiments, the three-dimensional modeling can be simplified by taking advantage of repetitive areas. For instance, in a boiler model, this aspect of the invention takes full advantage of repetition of tube geometry including a duplicator, a mirror image duplicator and several more. The three-dimensional geometry defines a number of benchmark nodes, which can be used in the model to reference particular locations. For instance, when operating on a boiler, the benchmark nodes can be used in the boiler to reference repair locations.

The data stored with regards to a device can include, but is not limited to, tests performed, tests results, repairs performed, inspection results, notes, inspection dates, problems reported, repair types, inspection types, wear observations, identification of persons performing actions, material requirements, operating and design constraints, etc.

Now, turning to the figures in which similar numbers refer to like elements throughout the several views, specific embodiments of the present invention are provided.

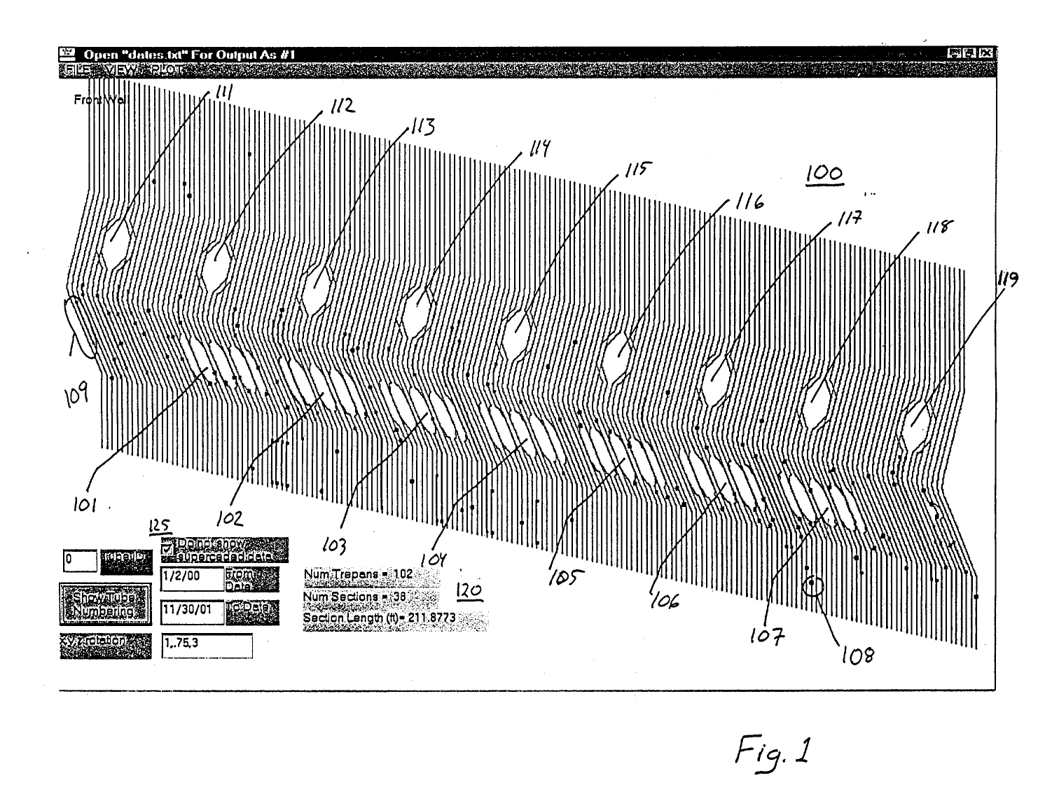

FIG. 1 is a screen shot of an exemplary embodiment of the present invention used in conjunction with the front wall in the burner area of a boiler. The graphical image of the front wall 100 includes the tube arrangement for seven burners 101-107 and nine over fire airports 111-119. Two different types of icons are overlaid on the model. One icon is a small dot 108 that represents a very isolated repair called a trepan. The other icon is two small dots connected by one or more line segments 109. This icon represents the replacement of a tube section. The data presented on this screen shot is obtained from the results of a database query. For instance, the database query may have requested a certain type of repair and limited the data to a particular period of time. A summary filed 120 identifies the total number of trepans and section repairs that are represented by the icons. This embodiment of the present invention gives the total length of the tube replaced this is a valuable tool in determining the amount of tube required during an outage for proposed repairs.

Several additional operations or capabilities can be provided with this embodiment of the present invention. One such capability is shown in the superseded data selection indicator box 125. In this embodiment, a user can activate or deactivate the display of superceded data—data that has been changed or modified.

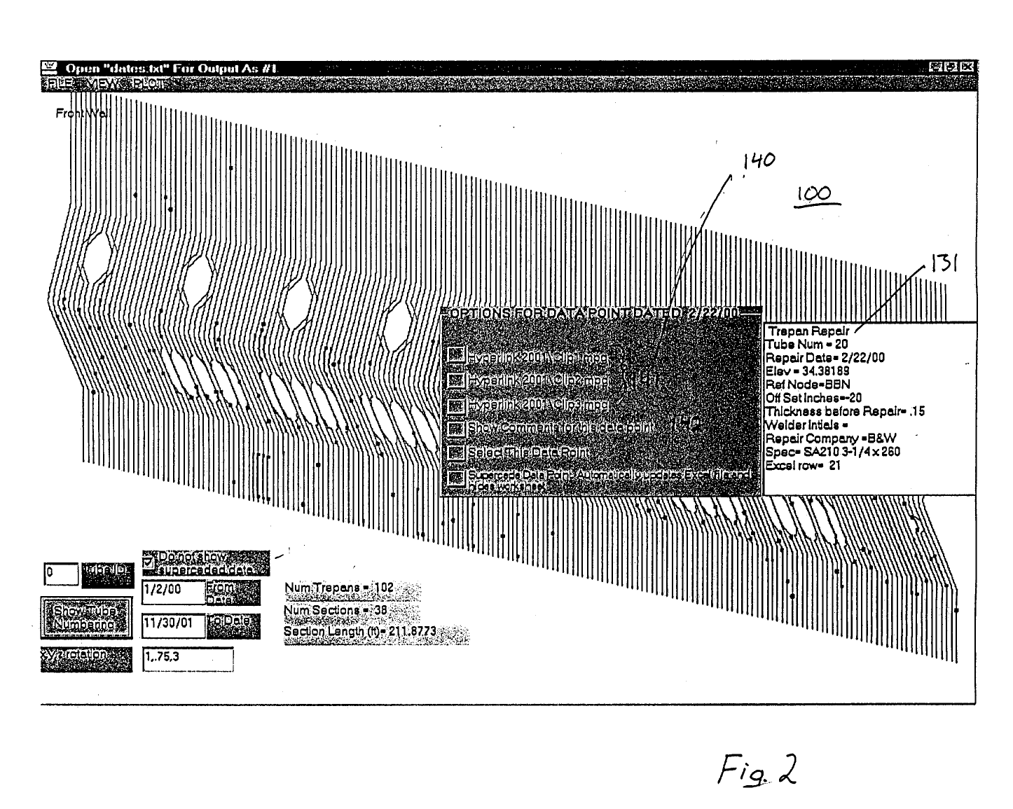

FIG. 2 is a screen shot illustrating the presentation of data when a pointing device is positioned over an icon. In this embodiment of the invention, data can be automatically displayed by moving a pointing device over an icon. Those skilled in the art will understand that other mechanisms can be utilized for extracting this information and the disclosed method is simply provided for illustrative purposes. In this embodiment, the data that is displayed is extracted from an Excel file running in the background; however, the data could be extracted from any database, a database program running in the background, or some other data retrieval system. The data pertaining to the selected icon includes an identification of the activity (trepan repair 131), the tube number, the repair date, and other specific information pertaining to the repair. In addition, a menu box 140 is displayed. The menu box provides a number of options or actions that can be performed by selecting the various items in the menu. In this particular example, the menu box 140 indicates that three hyperlinks 141 to video clips are available for viewing, comments 142 are available for viewing. In addition, the data point can be selected to provide additional information and the data point can be superceded.

The icons representing data can be associated with reference locations in a number of ways. This includes elevation and offset from benchmarks. Offset from benchmarks can be based on a vertical offset or an inclined offset based on the geometry of the object. For instance, in the tube wall, this can be done based on the geometry of the tube, ignoring side-to-side changes of the tube. This latter feature is most convenient since elevation measurements or offsets require time consuming surveying techniques to define locations accurate enough for repeatability. Each location defined in an underlying spreadsheet of information results in an icon that is automatically overlaid on the three-dimensional model display of the fire wall.

For both the three-dimensional and raster embodiments, the data that is associated with an icon is displayed onto the screen when the user places the pointing device over the icon. There are also options to allow all comments (including notepad type comments) in a spreadsheet associated with that icon to be presented as an overlay adjacent to the icon. Movie snippets of video inspections, jpeg photos and any other photo file type or audio file type can be displayed, viewed or listened to by clicking the proper option button that is displayed next to the selected icon.

Both the three-dimensional and raster embodiments can include a zoom feature. There is also a feature that will put selected data into superceded status if the repair or inspection is negated by a later repair. Old superceded repairs can also be displayed to allow a complete picture of repair history. The three-dimensional embodiment also has a rotate feature. When two icons are plotted very close to each other or overlaid due to reinspections, the user has the options of which data set to access. When such a case happens and the icons are related to the same tube, a thickness wear rate is calculated.

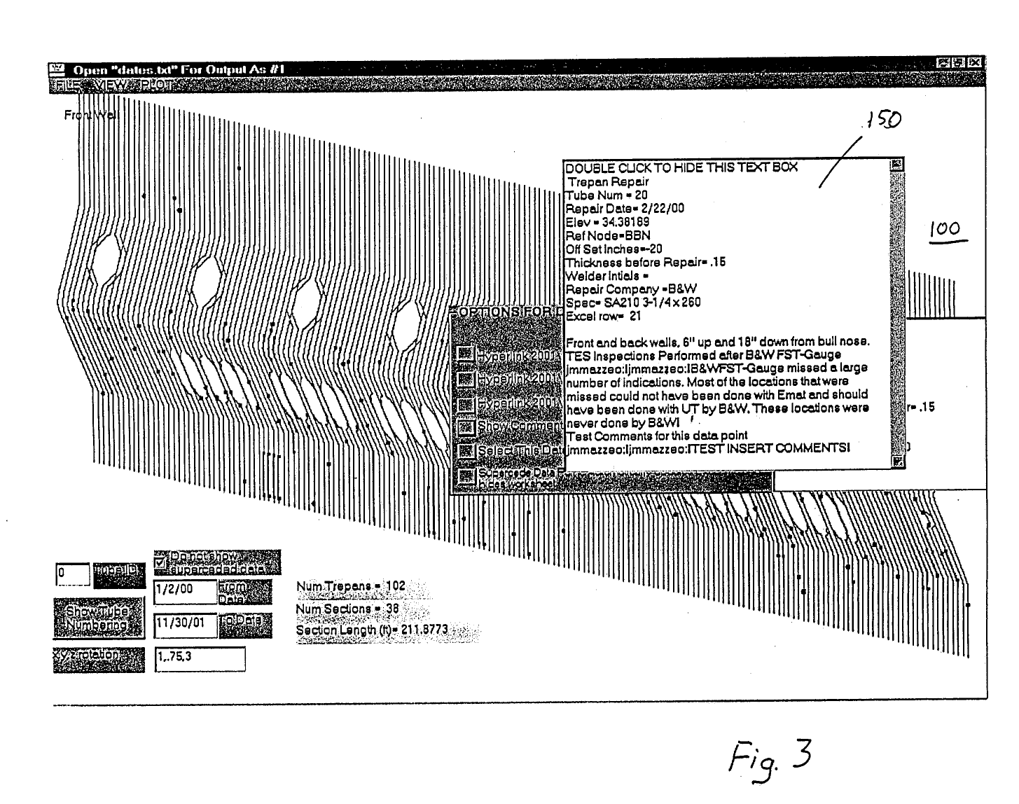

FIG. 3 is a screen shot illustrating the display of FIG. 2 when the comments 142 menu item is selected. A comments screen 150 is displayed that may or may not contain the previously displayed information and, additional information that may have been entered from a previous inspection or repair, from the manufacturer of the boiler to indicate particular specifications or operating parameters, or other additional information. The comments can come from a variety of sources, in a variety of formats and from a variety of database storage facilities.

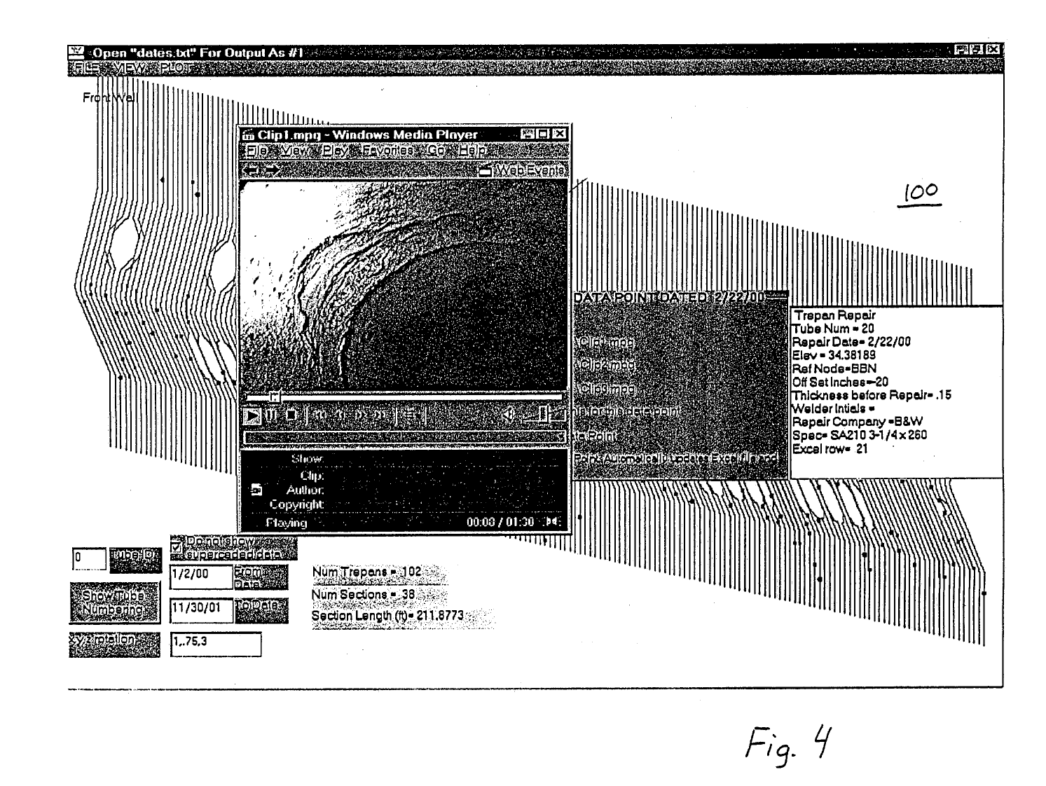

FIG. 4 is a screen shot illustrating the display of FIG. 2 when a hyperlink 141 menu item is selected. In one embodiment, a software program, such as the Window's Media Player, associated with the video file is used to present the video clip on the display. Such software programs are known to those skilled in the art. In another embodiment, the media player could be incorporated into the embodiment of the invention itself. Thus, the video clip 155 of information pertaining to the repair is displayed for the user to view, pause, study, or the like. It should be noted that multiple video files could be viewed at the same time and other types of files, such as audio files can also be accessed.

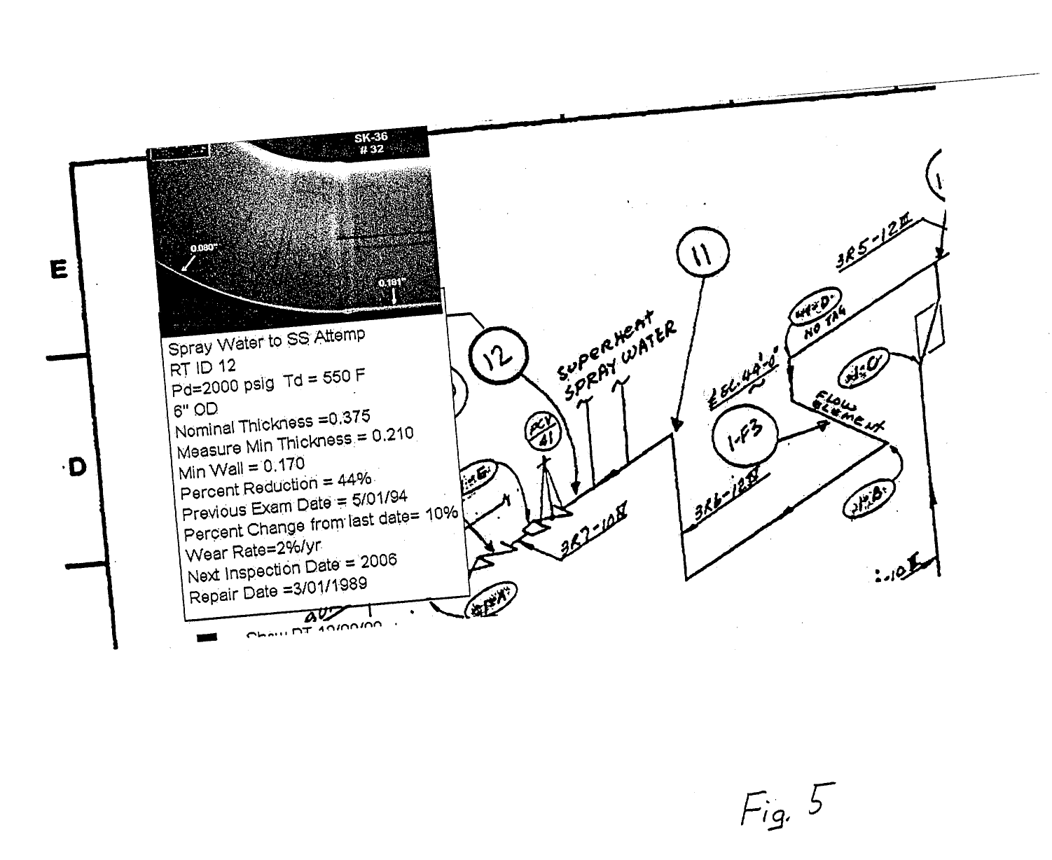

FIG. 5 is a screen shot of an embodiment using the raster file aspect of the present invention. In this embodiment, a scanned file of a drawing or sketch 160 is accessed. An icon is placed over the sketch, located manually by the user moving a pointing device to the location and selecting the location. In response to this action, an icon is created and a link is established between the icon and data information (such as an Excel spreadsheet). In the illustrated example, location 12 was selected as the icon. The information stored or linked in the database can subsequently be accessed by opening this raster file and clicking on the icon. Similar to the three-dimensional option, the icons can be selected based on date, repair category, etc.

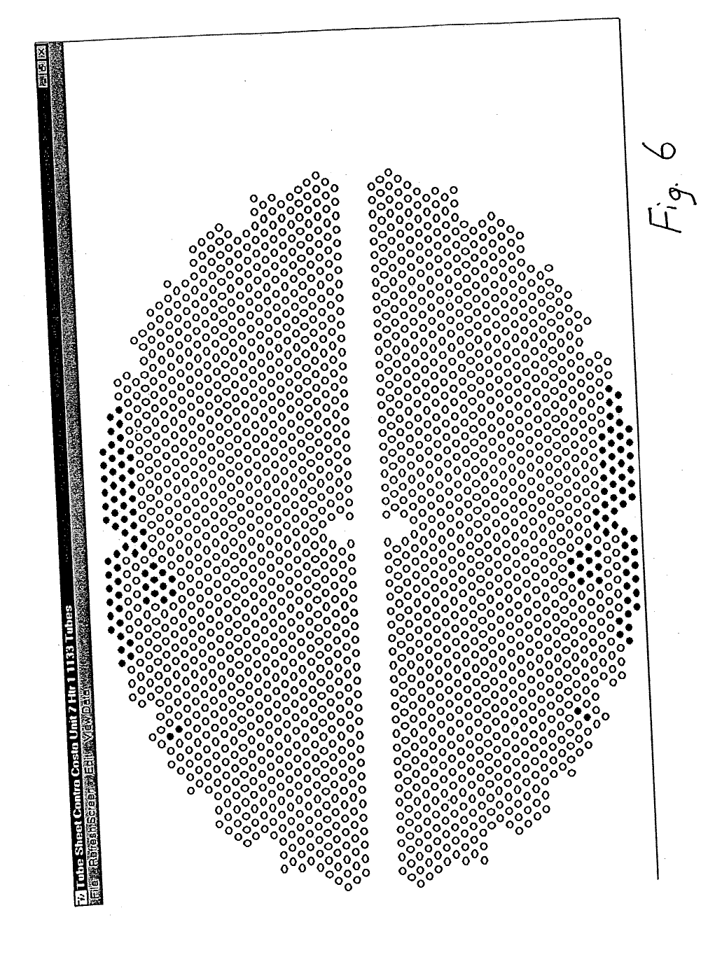

FIG. 6 is a screen shot of another embodiment using the raster file aspect of the present invention. The embodiment of this invention utilizes a two-dimensional model that can either be generated by the user inputting the geometric attributes, or with the aid of a raster file overlay. In this figure, a cross-section of a heat exchanger tube sheet 170 for a feedwater heater is presented with the tube openings being visible. Boiler feedwater (water that supplies the boiler that will be heated and turned to steam) enters into the channel inlet nozzle. The water enters through the openings in the tube sheet and into the tubes. The water flows horizontally and around U-tubes and flows horizontally to finally exiting the upper tube sheet and the channel outlet. The water in the tubes is heated by the steam that enters the shell through the shell steam inlet nozzle. The steam that is used is waste steam from the exhaust of the steam turbine. However, since this steam is used to heat the boiler feedwater, it reduces the amount of heat that the boiler has to put into the water to turn it into steam, thus the heat from the turbine exhaust is not wasted. Normally in fossil fuel steam plants there are 7 feedwater heaters. The heat exchanger has to be re-tubed or replaced from time to time. When a tube leaks, it must be plugged since the water inside the tube is much higher pressure than the steam pressure. The leaking tube must be plugged at both ends, which includes the lower tube sheet where the water enters and at the upper tube sheet where the water exits. In this embodiment, tubes that have activity information stored about them can be indicated by shading the tube opening, changing the color of the tube opening or the like. Typically, in this embodiment, when a tube is faulty, it is simply plugged. Thus, in the illustrated screen shot, a plugged tube is illustrated as being blackened. In addition, because the illustrated tube wall represents two segments of the same tubes (the upper section loops back to the lower section) there is symmetry between the plugged tubes in the upper section and the lower section.

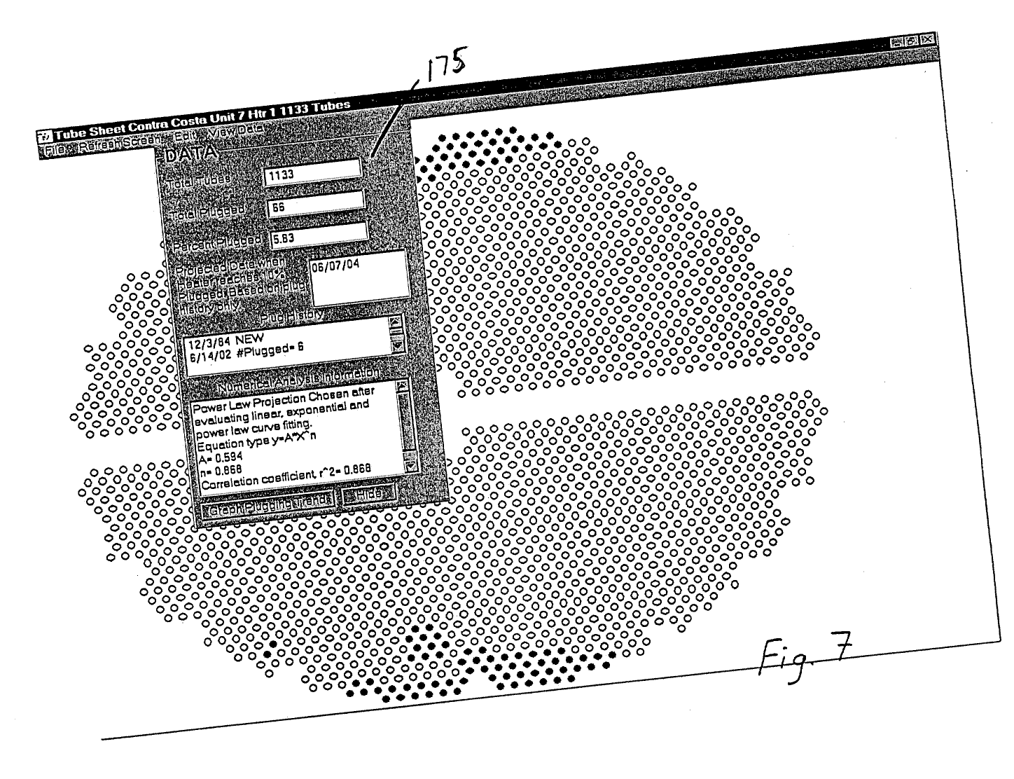

FIG. 7 is a screen shot of the tube sheet 170 illustrated in FIG. 6 upon selection of the view data menu. In this figure, a data window 175 is provided to indicate particular information about the component, such as, the total number of tubes, the number of tubes that have been plugged, the percentage of tubes that have been plugged, the history of the plugging operations, and numerical analysis information (which information can be used to project the remaining life of the feed water heater).

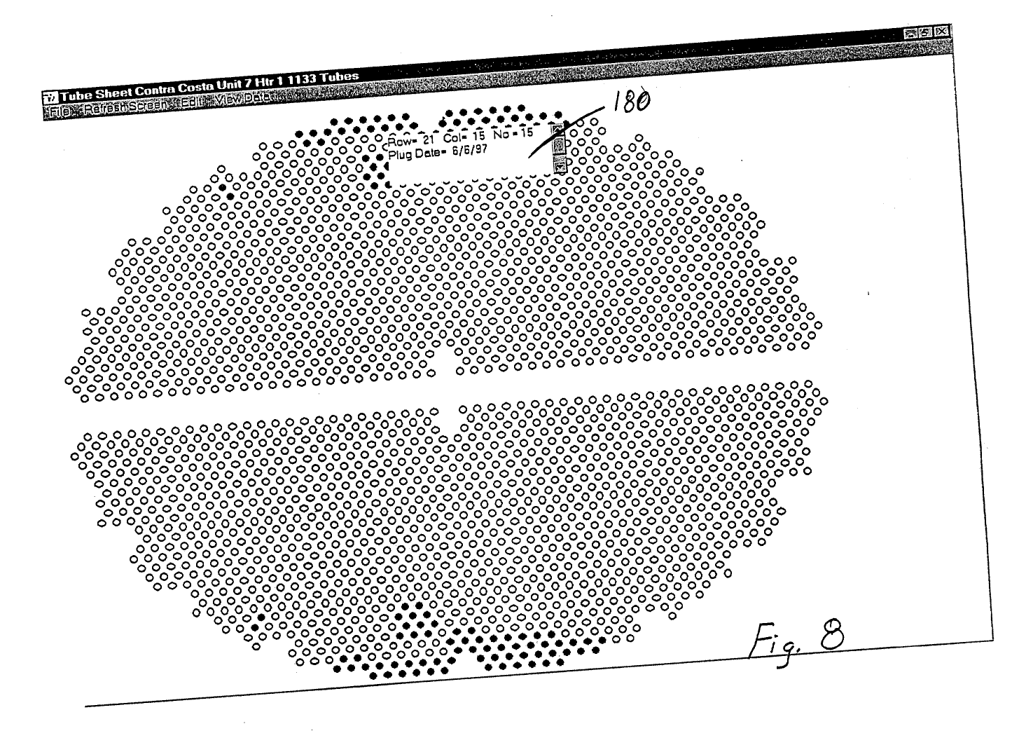

FIG. 8 is a screen shot of the tube sheet 170 illustrated in FIG. 6 upon the selection of an icon representing data for one of the tubes. In this figure, a data window 180 is provided that includes information pertinent to the particular tube. In this embodiment, the information includes the row and column number of the tube, an identification number, and the date that the tube was plugged. Additional information could also be provided such as, but not limited to, reasons for plugging the tube, the name of the technician performing the operation, etc.

It should be noted that the icons in either the raster or three-dimensional embodiments can be used to convey information by themselves. This can be accomplished by using differing colors or shapes or other similar characteristics. In the raster embodiment, it should also be noted that three-dimensional modeling can be implemented by layering of several raster files. In addition, other types of information can be stored and retrieved using the present invention and the examples provided herein are for illustrative purposes and should not limit the present invention.

### CONCLUSION

The present invention can be utilized to facilitate the management, retrieval and viewing of activity data for a variety of objects. A graphical representation of the object is presented on a display screen with an overlay of icons'. Each icon represents data that is available for viewing regarding an activity pertaining to a particular area of the object. By selecting the icon, the information can be reviewed.

Although this disclosure describes the present invention in terms of exemplary embodiments, the invention is not limited to those embodiments. Rather, a person skilled in the art will construe the appended claims broadly, to include other variants and embodiments of the invention, which those skilled in the art may make or use without departing from the scope and range of equivalents of the invention.

What is claimed is:

1. A method for displaying activity data related to a three-dimensional object, the method comprising the steps of:
displaying a graphical representation of a three-dimensional object;
associating a record indicator with a particular region of the three-dimensional object;
receiving a selection indicator for the record indicator;
retrieving an activity record for the particular region; and
displaying the activity record.

2. The method of claim 1, wherein the activity record includes video data, and the step of displaying the activity record further comprises displaying the video data.

3. The method of claim 1, wherein the activity record includes audio data, and the step of displaying the activity record further comprises playing the audio data.

4. The method of claim 1, wherein the graphical representation is a video image of the three dimensional object and the step of displaying the graphical representation comprises displaying the video image.

5. The method of claim 1, wherein the step of associating a record indicator with a particular region of the three-dimensional object further comprises overlaying an icon over the graphical representation.

6. The method of claim 5, wherein the step of receiving a selection indicator further comprises detecting a pointer device over the icon and detecting the actuation of an action device.

7. A system for maintaining and displaying activity records for a three-dimensional object, the system comprising:
a processing unit;
a display device communicatively coupled to the processing unit;
a memory device, accessible by the processing unit, for storing and retrieving activity records, a graphical representation of the three-dimensional object and an operation program;
a pointer device communicatively coupled to the processing unit;
the processing unit, in response to instructions in the operation program, being operable to:
display the graphical representation of three three-dimensional object;
overlay the graphical representation with at least one icon, wherein each icon is associated with at least one activity record;
receiving a selection indicator from the pointer device, the selection indicator being associated with a particular icon;
retrieving the at least one activity record associated with the particular icon; and
displaying the activity record on the display device.

8. The system of claim 7, wherein the activity record includes video data, and the processing unit is operative to display the activity record by displaying the video data.

9. The system of claim 7, wherein the icons are structured to convey information based on their shape.

10. The system of claim 7, wherein the icons are structured to convey information based on their color.

11. The system of claim 7, further comprising a data entry device and, wherein the processing unit is further operable to:
receive query parameters pertaining to the data records; and
is operable to retrieve at least one data record associated with the particular icon by limiting the retrieval based on the query parameters.

12. The system of claim 11, wherein the query parameters include a date range.

13. The system of claim 11, wherein the query parameters include an activity type.

14. The system of claim 11, wherein the query parameters include a date range and an activity type.

15. A method for displaying activity data for a three-dimensional object, the method comprising the steps of:
displaying a graphical representation of a three-dimensional object;
overlaying a plurality of icons on the graphical representation, each of the plurality of icons being associated with a particular region of the three-dimensional object;
storing a plurality of activity records, each activity record being associated with at least one icon;
receiving query parameters;
receiving a selection indicator for an icon;
retrieving at least one activity record for the particular region based on the selected icon and the query parameters; and
displaying the at least one activity record.

16. The method of claim 15, wherein the activity records includes video data, and the step of displaying the at least one activity record further comprises displaying the video data.

17. The method of claim 15, wherein the activity records includes audio data, and the step of displaying the at least on activity record further comprises playing the audio data.

18. The method of claim 15, wherein the graphical representation is a video image of the three dimensional object and the step of displaying the graphical representation comprises displaying the video image.

19. The method of claim 15, wherein the graphical representation is a scanned image of one aspect of the three-dimensional object and the step of displaying the graphical representation comprises displaying the video image.

20. The method of claim 15, wherein the step of receiving a selection indicator further comprises detecting a pointer device over the icon and detecting the actuation of an action device.
